(19) United States
(12) Patent Application Publication
(10) Pub. No.: US 2024/0013133 A1
(43) Pub. Date: Jan. 11, 2024

(54) SYSTEM AND METHOD FOR PRODUCING VEHICLES

(71) Applicants: Hyundai Motor Company, Seoul (KR); Kia Corporation, Seoul (KR)

(72) Inventor: Seung Hyeon Kim, Goyang-si (KR)

(21) Appl. No.: 18/074,712

(22) Filed: Dec. 5, 2022

(30) Foreign Application Priority Data
Jul. 7, 2022 (KR) 10-2022-0083841

(51) Int. Cl. G06Q 10/0833; G06Q 10/0631

(52) U.S. Cl. CPC G06Q 10/0833; G06Q 10/06312

(57) ABSTRACT

Disclosed herein are a system and a method including receiving a request for changing a delivery date of a purchased vehicle, and selecting, among a plurality of planned vehicles for which production planning and delivery dates have been previously determined, a target vehicle. Exchanging the delivery date of the purchased vehicle with a delivery date of the target vehicle may not affect delivery dates of other planned vehicles of the plurality of planned vehicles. The system and method may further include exchanging the delivery date of the purchased vehicle with the delivery date of the target vehicle, and adjusting a vehicle production schedule according to the exchanged delivery dates.

### CROSS REFERENCE TO RELATED APPLICATION

The present application claims priority of Korean Patent Application No. 10-2022-0083841 filed on Jul. 7, 2022, the entire contents of which is incorporated herein for all purposes by this reference.

### BACKGROUND

### Field

The present disclosure relates to a system and a method for producing vehicles, and more specifically, to a system and a method for producing vehicles and predicting a delivery schedule.

### Description of the Related Art

Generally, a vehicle buyer (hereinafter referred to as a “customer”) who intends to purchase a vehicle may visit vehicle dealerships of various brands first so as to select a vehicle to purchase and determine the designs and performance of vehicles, and when a brand and a type of a vehicle to purchase are determined, the customer may visit a vehicle dealership of the corresponding brand and obtain an estimate for a desired type of a vehicle from a vehicle dealer (hereinafter referred to as a “sales staff”).

In this case, the customer may be informed of an expected due date of an ordered vehicle (hereinafter referred to as a “purchase vehicle”) through the sales staff when ordering the vehicle. The expected due date is generally calculated on a monthly basis for each month.

However, the expected due date calculated on a monthly basis may not reflect changes in the total amount of work and required work time at each plant in real time so that there is a problem in that customer satisfaction is negatively affected due to the difference between the expected due date and an actual delivery date.

In addition, according to the existing general vehicle purchase method, a selection range of desired due dates that the customer can select is very limited.

Specifically, even when the customer confirms the purchase of the vehicle, a desired due date can be confirmed from about two weeks in advance on the basis of a “vehicle sign off” in which the production planning of the purchased vehicle is established. Until the production planning is established, only an approximate period such as “after about X months” is provided, and thus the customer cannot confirm a firm due date of the purchased vehicle at the point of purchase of the vehicle.

In addition, since the desired due date and a delivery date are determined according to the production planning, there is inconvenience in that the desired due date cannot be earlier than the expected due date at a point of time when the customer concludes the purchase contract for the vehicle, and the desired due date cannot be advanced earlier than the informed expected due date after the purchase is confirmed.

Therefore, there exists a need to provide a vehicle production sales system capable of solving the above inconvenience.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a system and a method for producing vehicles and managing a production schedule, which allow a customer to move up a desired due date (e.g., delivery date) of a purchase vehicle from an expected due date, even when due date of the target vehicle is exchanged with a due date of a purchase vehicle among planned vehicles for which a production planning and due dates are previously set, by selecting a target vehicle not affecting due dates of other vehicles, thereby changing a due date of a vehicle through a method of exchanging the due date of the purchase vehicle with a due date of a target vehicle.

According to one or more embodiments of the present disclosure, a system may include one or more processors and memory. The memory may store instructions that, when executed by the one or more processors, cause the system to receive a request for changing a delivery date of a purchased vehicle; and select, among a plurality of planned vehicles for which production planning and delivery dates have been previously determined, a target vehicle, wherein exchanging the delivery date of the purchased vehicle with a delivery date of the target vehicle does not affect delivery dates of other planned vehicles of the plurality of planned vehicles; exchange the delivery date of the purchased vehicle with the delivery date of the target vehicle; and adjust a vehicle production schedule according to the exchanged delivery dates.

The instructions, when executed by the one or more processors, may further cause the system to: store information on the plurality of planned vehicles; and execute the vehicle production schedule based on the stored information.

The instructions, when executed by the one or more processors, may cause the system to select the target vehicle based on at least one of an amount of work or an amount of production time performed in a production process of the purchased vehicle.

The instructions, when executed by the one or more processors, may cause the system to select the target vehicle based on at least one of an amount of work or an amount of production time performed in a production process of the target vehicle being similar to a corresponding at least one of the amount of work or the amount of production time performed in the production process of the purchased vehicle.

The instructions, when executed by the one or more processors, may cause the system to not select, as the target vehicle, a vehicle having at least one of an amount of work or an amount of production time that is less than a corresponding at least one of the amount of work or the amount of production time performed in the production process of the purchased vehicle.

The instructions, when executed by the one or more processors, may cause the system to receive the request at a time of purchase of the purchased vehicle.

The instructions, when executed by the one or more processors, may cause the system to receive the request after a time of purchase of the vehicle before the production planning of the purchased vehicle is established.

The instructions, when executed by the one or more processors, may further cause the system to: receive, from a user, an input including the request; retrieve information on the plurality of planned vehicles; and provide the information to the user.

The instructions, when executed by the one or more processors, may further cause the system to, based on receiving from a user an input including the request, retrieve information on the target vehicle and provide the information to the user.

According to one or more embodiments of the present disclosure, a method may include: receiving, via one or more processors, a request for changing a delivery date of a purchased vehicle; selecting, among a plurality of planned vehicles for which production planning and delivery dates have been previously determined, a target vehicle, wherein exchanging the delivery date of the purchased vehicle with a delivery date of the target vehicle does not affect delivery dates of other planned vehicles of the plurality of planned vehicles; and exchanging the delivery date of the purchased vehicle with the delivery date of the target vehicle; and adjusting a vehicle production schedule according to the exchanged delivery dates.

Receiving of the request may include receiving the request after a time of purchase of the vehicle before the production planning of the purchased vehicle is established.

Receiving of the request may include receiving the request at a time of purchase of the purchased vehicle. The method may further include generating, based on the request, order information of the purchased vehicle. Adjusting of the vehicle production schedule may include establishing the vehicle production schedule based on the order information.

The method may further include, based on the receiving of the request, transmitting information on the request to a production information management server.

Selecting of the target vehicle may include selecting the target vehicle based on at least one of an amount of work or an amount of production time performed in a production process of the purchased vehicle.

The method may further include: receiving, from a user, an input including the request; retrieving information on the target vehicle; and providing the information to the user.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a diagram illustrating a system for producing vehicles and predicting a delivery schedule;

FIG. 2 is a flowchart illustrating a method of producing vehicles and predicting a delivery schedule; and

FIGS. 3A and 3B are diagrams for describing a method of selecting a target vehicle.

### DETAILED DESCRIPTION

In the entire specification, the terms “comprising,” “having,” “including,” or the like are used to specify that a feature, a number, a step, an operation, a component, an element, or a combination thereof described herein exists, and they do not preclude the presence or addition of one or more other features, numbers, steps, operations, components, elements, or combinations thereof.

In addition, terms including ordinal numbers such as first, second, and the like used herein may be used to describe various components, but the various components are not limited by these terms. The terms are used only for the purpose of distinguishing one component from another component.

Specific structural and functional descriptions of the embodiments disclosed in the specification are illustrative only for the purpose of describing the embodiments, and the embodiments according to the present disclosure may be implemented in various forms and should not be construed as being limited to embodiments described in the specification.

In the following description of the present specification, when a detailed description of a known related art is determined to obscure the gist of the present specification, the detailed description thereof will be omitted herein. In addition, the accompanying drawings are merely for easy understanding of the embodiments disclosed in the present specification, the technical spirit disclosed in the present specification is not limited by the accompanying drawings, and it should be understood to include all modifications, equivalents, and substitutes included in the spirit and scope of the present disclosure.

Unless defined otherwise, all terms including technical or scientific terms used herein have the same meaning as commonly understood by those skill in the art to which the present disclosure pertains. General terms that are defined in a dictionary shall be construed to have meanings that are consistent in the context of the relevant art and will not be interpreted as having an idealistic or excessively formalistic meaning unless clearly defined in the present specification.

Hereinafter, configurations and operating principles of various embodiments of the present disclosure will be described in detail with reference to the accompanying drawings, and regardless of the reference numerals, the same or similar components are given the same reference numbers, and duplicate descriptions thereof will be omitted herein.

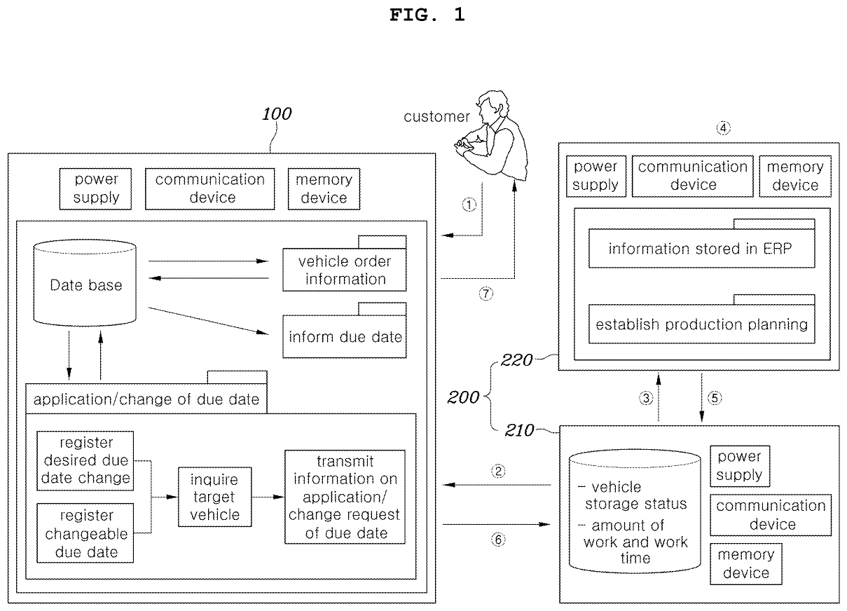

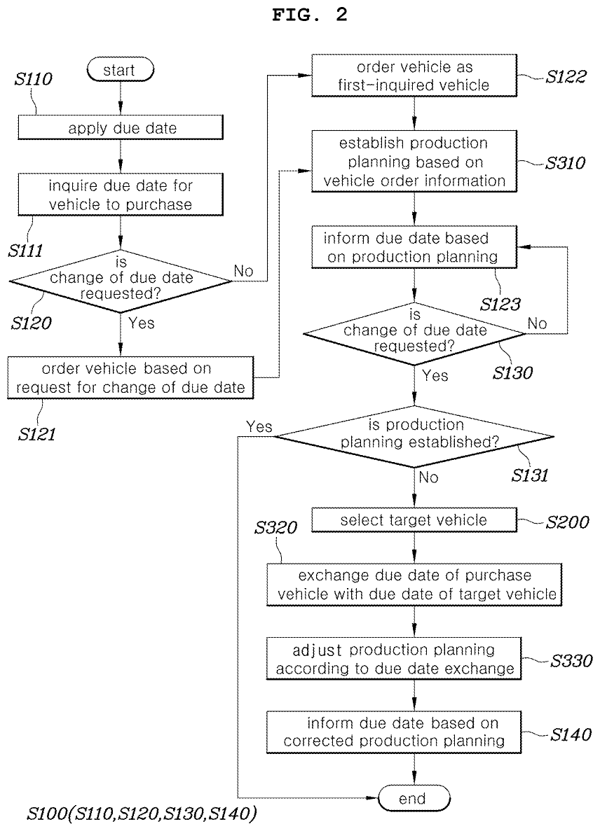

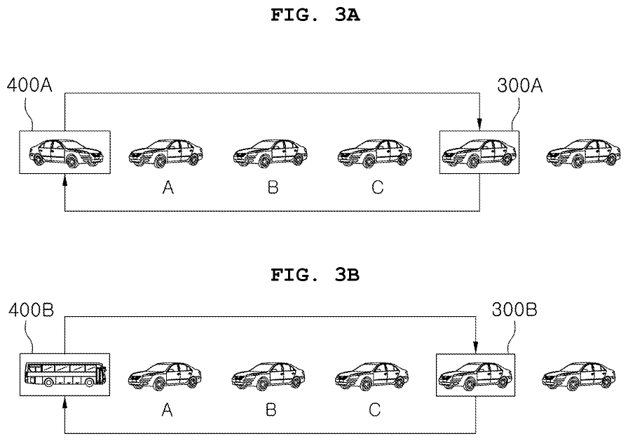

FIG. 1 is a diagram illustrating a system for producing vehicles and predicting a delivery schedule, FIG. 2 is a flowchart illustrating a method of producing vehicles and predicting a delivery schedule, and FIGS. 3A and 3B are diagrams for describing a method of selecting a target vehicle.

For reference, FIG. 1 mainly shows a configuration related to the present embodiment, and in actual implementation of the system, fewer or more components than what is shown in FIG. 1 may be included.

Referring to FIG. 1, a system for producing vehicles and predicting a delivery schedule may include a customer management part (e.g., customer management server) 100 configured to receive an application or a request for change of a due date (e.g., delivery date) of a purchased vehicle; and a production management part (e.g., production management server) 200 configured to receive the application or the request for change of the due date of the purchased vehicle from the customer management part 100, select a target vehicle that does not affect due dates (e.g., delivery dates) of other vehicles even when a due date of the target vehicle is exchanged with a due date of a purchased vehicle among planned vehicles for which production planning and due dates are previously set, exchange the due date of the purchased vehicle with the due date of the target vehicle, and adjust vehicle production planning according to the due date exchange. A due date or delivery date may refer to the earliest date on which a vehicle becomes available for a retrieval (e.g., a pick-up) by a customer and/or the actual date of retrieval by the customer.

Here, the production management part 200 may include a production information management part (e.g., production information management server) 210 configured to receive the application or the request for change of the due date of the purchased vehicle from customer management part 100, store information on planned vehicles for which the production planning and due dates are previously set, and select the target vehicle that does not affect the due dates of other vehicles even when the due date of the target vehicle is exchanged with the due date of the purchased vehicle among the planned vehicles for which the production planning and the due dates are previously set, and a production planning management part (e.g., production planning management server) 220 configured to establish the vehicle production planning on the basis of the information stored in the production information management part 210, exchange the due date of the purchased vehicle with the due date of the target vehicle, and adjust the vehicle production planning according to the due date exchange.

Specifically, the customer management part 100 may receive the application or the request for change of the due date of the purchased vehicle from the customer (01) of FIG. 1). In addition, the customer management part 100 may transmit the received application or the received request for change of the due date of the purchased vehicle to the production information management part 210 (T of FIG. 1).

When the application or the request for change of the due date of the purchased vehicle is received from the customer management part 100, the production information management part 210 may select the target vehicle on the basis of pre-stored information. Here, the “pre-stored information” means information on the planned vehicles for which the production planning and due dates have been previously set.

More specifically, the information on the planned vehicles for which the production planning and the due dates are previously set may be understood to mean information on vehicles for which the production planning is established and the expected due dates have been previously set among vehicles for which customers have confirmed the purchasing.

In addition, the production information management part 210 may select, among the planned vehicles for which the production planning and the due dates have been previously set, a target vehicle that does not affect due dates of other vehicles even when the due date of the purchased vehicle is exchanged with a due date of the target vehicle. Here, a detailed method of selecting, by the production information management part 210, the target vehicle will be described below.

Subsequently, the production planning management part 220 may establish the vehicle production planning on the basis of the information stored in the production information management part 210 (\textcircled{3} and \textcircled{4} in FIG. 1). If the target vehicle is selected by the production information management part 210, the production planning management part 220 may exchange the due date of the purchased vehicle with the due date of the target vehicle, and adjust the vehicle production planning according to the due date exchange.

As a result, the system for producing and selling vehicles according to the present disclosure may change an expected due date of the purchased vehicle to a desired due date of the customer through the above processes (\textcircled{5} and \textcircled{6}) of FIG. 1).

Meanwhile, in the automobile industry, vehicles may be generally produced through a build-to-stock (BTS) method on the basis of a predicted demand, and recently, attempts to apply a build-to-order (BTO) method are increasing.

The BTO method refers to a production method of taking orders first and manufacturing a product, and has an advantage of reducing inventory compared to the existing predictive production method (e.g., the BTS method).

In addition, in terms of reflecting customer needs more faithfully, attempts to introduce the BTO method are continuously being made not only in the automobile industry but also in various other manufacturing fields.

As described above, in the system for producing vehicles and predicting a production schedule according to the present disclosure, since the information on the planned vehicles for which the production planning and the due date are previously set is pre-stored in the production information management part 210, there is an advantage of being able to apply the information not only to the existing BTS method but also to a case of using the BTO method.

For reference, the customer management part 100, the production information management part 210, and the production planning management part 220 of the system for producing and selling vehicles according to the present disclosure may be integrated with one computing device (e.g., server) or may be individually implemented in separate computing devices (e.g., servers). One or more computing devices as described herein, may include at least one processor, a memory, a user interface input device, a user interface output device, storage, and/or a network interface connected through a bus. The processor may be a central processing device (CPU) and/or any semiconductor device that processes instructions stored in the memory and/or the storage. The memory and the storage may include various types of volatile or non-volatile storage media. For example, the memory may include a read-only memory (ROM) and a random access memory (RAM). The processes of the method or algorithm described in relation to the embodiments of the present disclosure may be implemented by hardware executed by the processor, a software module, or a combination thereof. The software module may reside in a storage medium (e.g., the memory and/or the storage), such as a RAM, a flash memory, a ROM, an erasable programmable read-only memory (EPROM), an EEPROM, a register, a hard disk, solid-state drive (SSD), a detachable disk, or a compact disc read-only memory (CD-ROM). The exemplary storage medium is coupled to the processor, and the processor may read information from the storage medium and may write information in the storage medium. In another method, the storage medium may be integrated with the processor. The processor and the storage medium may reside in an application specific integrated circuit (ASIC). The ASIC may reside in a user terminal. The processor and the storage medium may reside in the user terminal as an individual component.

As shown in FIG. 1, the production information management part 210 may further store vehicle production information including information on a storage status of a vehicle and on the amount of work or a production time, and the production planning management part 220 may establish production planning on the basis of the production information stored in the production information management part 210.

For example, the production information management part 210 may acquire the production information on the basis of an enterprise resource planning (ERP) system and a manufacturing execution system (MES) (not shown).

The ERP system refers to a system for automating and managing business processes for finance, manufacturing, a retail distribution, a supply chain, a personnel management, and/or an operation. Like the ERP system, the MES (not shown) refers to a system for managing a business process, but there is a difference in data collection and a point of time of processing between the systems.

The MES (not shown) corresponds to a management system which provides field status information in real time and is related to actual production such as a manufacturing process and a resource management, whereas the ERP system corresponds to a system for only checking and processing the results after data collection is completed.

That is, since the MES (not shown) collects and manages data in real time, immediate management is possible when a problem such as a work delay occurs. However, since the ERP system checks the results of completion, there is a problem in that it is difficult to track which process in which the problem occurs and to take immediate action.

Therefore, the production information management part 210 of the system for producing vehicles and predicting a production schedule according to the present disclosure may acquire real-time production information through the MES (not shown) and store the obtained production information in the ERP system and transmit the production information to the production planning management part 220. However, the above description is illustrative and the content of the present disclosure is not necessarily limited thereto.

Subsequently, the vehicle production planning in the production planning management part 220 may be established through an advanced planning and scheduling (APS) system. The APS system supports appropriate decision-making as a new approach for optimal planning and scheduling so as to synchronize multiple variables with constraints to realize the appropriate decision-making, and it is desirable to understand the APS system as a system for securing the competitiveness of a company, such as production planning capability, inventory reduction, read time reduction, and customer service improvement.

Meanwhile, as shown in FIG. 1, each of the APS system, the ERP system, and the customer management part 100 may be equipped with a power supply, a communication device, and a memory device. Here, the power supply, the communication device, the memory device, and an interface are merely examples for assisting understanding of the present disclosure, and components of the present disclosure are not necessarily limited by such examples.

In addition, the customer management part 100 may be further provided with an interface (not shown) to inform (e.g., display) the due date (e.g., delivery date) to the customer. The customer management part 100 may inform (e.g., display) a changed due date to the customer through the interface (not shown) (\textcircled{7} of FIG. 1).

For reference, a process for processing information on a due date application or a request for change is briefly shown in a lower end portion of the customer management part 100 shown in FIG. 1 and will be further described after describing a method in which the production information management part 210 selects a target vehicle with reference to FIGS. 3A and 3B first.

In the present disclosure, the target vehicle may correspond to a vehicle, whose delivery schedule change (e.g., a delayed due date) does not affect due dates of other vehicles even when a due date of the purchased vehicle is exchanged with a due date of the target vehicle among the planned vehicles and is selected according to whether the due date is delayed.

Whether the due date is delayed may be determined by various factors such as the amount of work performed in the production process of the vehicle, a production time, options installed on the vehicle, a type of the vehicle, and a supply and demand status of parts constituting the vehicle.

Hereinafter, in the present disclosure, in order to assist understanding of the present disclosure, the amount of work or the production time performed in the production process of the vehicle among the determining factors of whether the due date is delayed will be described.

FIGS. 3A and 3B are diagrams for describing a method of selecting a target vehicle in a production information management part 210.

Referring to FIG. 3A, the production management part 200 of the system for producing and managing a production schedule of vehicles according to the present disclosure may select the target vehicle 400A on the basis of the amount of work or the production time performed in the production process of the vehicle. Here, the production management part 200 may be understood to refer to the production information management part 210 and may be also understood as described above in the following specification.

Specifically, the production management part 200 may select, as the target vehicle 400A, a vehicle that has the amount of work or a production time similar (e.g., a difference being within a threshold value) to the amount of work or the production time performed in the production process of a purchased vehicle 300 among the planned vehicles for which the production planning and the due dates have been previously set.

FIG. 3A shows planned vehicles A, B, and C for which the production planning and due dates have been previously set, the purchased vehicle 300A that the customer confirms to purchase, and the target vehicle 400A not affecting due dates of other vehicles even when a due date of the purchased vehicle 300A is exchanged with a due date of the target vehicle 400A among the planned vehicles A, B, and C are shown.

That is, the target vehicle 400A and the purchased vehicle 300A which are shown in FIG. 3A may have been different vehicle models, but the two vehicles may correspond to a compact passenger car, and the amounts of work or the production times performed in the production process may be similar to each other.

Therefore, even when the due date of the purchased vehicle 300A is exchanged with the due date of the target vehicle 400A, the due dates of the planned vehicles A, B, and C are not affected so that a vehicle, which has an amount of work and/or a production time that is similar to that of the target vehicle 400A and is performed in the production process, may be selected as the target vehicle 400A.

In addition, the production management part 200 of the system for producing and selling vehicles according to the present disclosure may choose not to select, as the target vehicle 400A, a vehicle having the amount of work or a production time that is less than the amount of work or the production time performed in the production process of the purchased vehicle 300A among the planned vehicles for which the production planning and the due dates have been previously set. Similar to the diagram shown in FIG. 3A, the diagram of FIG. 3B shows planned vehicles A, B, and C, for which the production planning and due dates are previously set, a purchased vehicle 300B that the customer confirms to purchase, and a target vehicle 400B that does not affect due dates of other vehicles even when a due date of the purchased vehicle 300B is exchanged with a due date of the target vehicle 400B among the planned vehicles A, B, and C. After the due dates are exchanged, the production schedule may be adjusted accordingly such that the purchase vehicle 300B may be manufactured first, then the planned vehicles A, B, and C, and then the target vehicle 400B.

In this case, unlike the target vehicle 400A shown in FIG. 3A, the target vehicle 400B shown in FIG. 3B is shown as an example of a large vehicle such as a bus. Large vehicles generally require more work than small (e.g., compact) vehicles and require more production time.

That is, as shown in FIG. 3B, when the purchased vehicle 300B may correspond to a compact vehicle and the target vehicle 400B may correspond to a large vehicle, since the amount of work or the production time performed in the production process of the target vehicle 400B is greater than the amount of work or the production time performed in the production process of the purchased vehicle 300B, even if the due date of the purchased vehicle 300B were to be exchanged with the due date of the target vehicle 400B, the due dates of the planned vehicles A, B, and C for which the production planning and the due dates have been previously set are not negatively affected.

On the other hand, unlike in FIG. 3B, if the purchased vehicle 300B corresponds to a large vehicle and the target vehicle 400B corresponds to a compact vehicle, since the amount of work or the production time performed in the production process of the target vehicle 400B would be less than the amount of work or the production time performed in the production process of the purchased vehicle 300B, if the due date of the purchased vehicle 300B were to be exchanged with the due date of the target vehicle 400B, there would occur a problem in that the due dates of the planned vehicles A, B, and C for which the production planning and the due dates previously set would be delayed (e.g., negatively affected).

Thus, the production management part 200 may choose not to select and excludes a vehicle having the amount of work or a production time, which is less than the amount of work or the production time performed in the production process of the purchased vehicle 300B among the planned vehicles for which the production planning and the due dates are previously set, as the target vehicle 400B so that a problem of the delay of the due dates of the other vehicles is prevented.

Next, the process for processing information on a due date application or a request for change shown in the lower end portion of the customer management part 100 in FIG. 1 will be described.

First, the customer wishing to change the due date may request a change of the due date by registering a desired due date change through the customer management part 100.

In addition, after the purchase of the vehicle is confirmed, the customer may register (e.g., input, confirm, etc.) whether the due date is changeable. When the customer registers the due date as being changeable, a corresponding vehicle may be classified as a vehicle for which due date is changeable and this information may be stored in the production information management part 210.

If the customer wishing to change the due date may register a desired due date change, the customer management part 100 may retrieve information on target vehicles stored in the production information management part 210 to provide the information to the customer and transmit information on the vehicle selected by the customer among the pieces of provided information on the target vehicles (e.g., due date application/request for change information as shown in FIG. 1) to the production information management part 210.

If a due date is exchanged with a due date of another vehicle, the customer of the vehicle (e.g., a target vehicle) classified as having a flexible due date may receive a certain amount of money (e.g., reward money) from a customer who wishes to change a due date. Therefore, it is possible to induce voluntary participation from customers after the purchase of the vehicle is confirmed.

In this case, a company operating the system for producing and predicting a production schedule for vehicles according to the present disclosure may receive a predetermined fee (e.g., a predetermined portion) from the reward money. When the customer of the vehicle (e.g., a target vehicle) classified as having a flexible due date exchanges the due date with a due date of another vehicle, receives the reward money, and subsequently cancel the purchase (e.g., reservation) of the vehicle, the received reward money may be credited back to the company operating the system for producing vehicles according to the present disclosure.

Through the above-described processes, the customer management part 100 according to the present disclosure may process the information on the due date application or the request for change, and accordingly, there is an advantage in that the customer can specifically confirm the desired due date of the purchased vehicle.

On the other hand, the customer management part 100 of the system for producing and selling vehicles according to the present disclosure may be characterized in that the customer management part 100 receives the application or the request for change of the due date of the purchased vehicle at a time of purchase of the vehicle.

In addition, the customer management part 100 of the system for producing and selling vehicles according to the present disclosure may be characterized in that the customer management part 100 receives the application or the request for change of the due date of the purchased vehicle after the time of purchase of the vehicle before the production planning of the purchased vehicle is established.

That is, the customer management part 100 of the present disclosure may receive the application or the request for change of the due date of the purchased vehicle from the time of purchase of the vehicle or after the point of purchase of the vehicle until the production planning of the purchased vehicle is established.

Among the vehicles classified as having a flexible due date, a changed due date schedule when establishing next production planning in the production planning management part 220 of the present disclosure may be reflected to a vehicle receiving the request for change of the due date.

When the customer who confirms the purchase of the vehicle inputs (e.g., submits) the application or the request for change of the due date of the purchased vehicle into the customer management part 100 at the time of purchase of the vehicle, the production planning management part 220 may establish production planning of the purchased vehicle by applying the due date schedule according to the application or the request for change of the due date from the beginning. Accordingly, the customer may be able to specifically confirm the desired due date of the purchased vehicle at the time of purchase of the vehicle.

On the other hand, if the customer who confirms the purchase of the vehicle inputs (e.g., submits) the application or the request for change of the due date of the purchased vehicle into the customer management part 100 after the time of purchase of the vehicle until the production planning of the purchased vehicle is established, the production planning management part 220 may apply the due date schedule according to the application or the request for change of the due date when establishing the next production planning. Accordingly, there is an advantage in that the customer may specifically confirm the desired due date of the purchased vehicle even after confirming the purchase of the vehicle, and the desired due date may be moved up than the expected due date.

On the other hand, when the request for change of the due date of the purchased vehicle is input (e.g., submitted), the customer management part 100 of the system may receive the information on the planned vehicles for which the production planning and the due dates are previously set from the production information management part 210 and provide the information to the customer.

More specifically, when the request for change of the due date of the purchased vehicle is input, the customer management part 100 may receive the information on the target vehicle that does not affect the due dates of other vehicles from the production information management part 210, even when the due date of the purchased vehicle is exchanged with the due date of the target vehicle among the planned vehicles for which the production planning and the due dates are previously set, and provide the information to the customer.

That is, when the request for change of the due date is input by the customer who wants to change the due date, the customer management part 100 may receive the information on the planned vehicles for which the production planning and the due dates have been previously set from the production information management part 210 and provide the information to the customer and receive the information on target vehicles that do not affect the due dates of other vehicles even when the due date of the purchased vehicle is exchanged with the due dates of the target vehicles among the planned vehicles.

Then, the customer may access the information on the target vehicle provided through the customer management part 100 and select a desired due date among the expected due dates of the target vehicles. The information on the vehicle selected by the customer may be transmitted to and stored in the production information management part 210 and transmitted to the production planning management part 220, so that the exchange of the due dates between the purchased vehicle and the target vehicle and adjustment of the vehicle production planning according to the exchange of the due dates may be performed.

For reference, as described above, the information on the planned vehicles and the target vehicles may be provided to the customer through the interface (not shown) separately provided in the customer management part 100.

FIG. 2 is a flowchart illustrating a method of producing vehicles and predicting a delivery schedule.

Referring to FIG. 2, the method of producing vehicles and predicting a delivery schedule may include receiving, by the customer management part 100, an application or a request for change of a due date of a purchased vehicle (S100), selecting, by the production information management part 210, a target vehicle that does not affect due dates of other vehicles even if the due date of the purchased vehicle is exchanged with a due date of the target vehicle among planned vehicles for which production planning and due dates have been previously set (S200), and exchanging, by the production planning management part 220, the due date of the purchased vehicle with the due date of the target vehicle and correcting vehicle production planning according to the exchange of the due dates (S310, S320, and S330).

Specifically, in S100, the customer management part 100 may receive the application or the request for change of the due date of the purchased vehicle at the time of purchase or at some time after the purchase of the vehicle and before the production planning of the purchased vehicle is established (S110, S120, and S130).

In S100, if the customer management part 100 receives the request for change of the due date of the purchased vehicle at the time of purchase of the vehicle (S120), order information of the vehicle may be generated based on the request for change of the due date (S121. In the adjusting of the vehicle production planning (S310, S320, and S330), vehicle production planning may be established in the production planning management part 220 based on the order information of the vehicle generated in the customer management part 100 (S310).

In the receiving of the application or the request for change of the due date of the purchased vehicle (S100), if the request for change of the due date of the purchased vehicle is received some time after the purchase of the vehicle and before the production planning of the purchased vehicle is established (S130 and S131), the customer management part 100 may transmit the information on the request for change of the due date the production information management part 210.

In the selecting of the target vehicle (S200), the production information management part 210 may select the target vehicle based on the amount of work or a production time performed in the production process of the vehicle.

In the receiving of the application or the request for change of the due date of the purchased vehicle (S100), if the request for change of the due date of the purchased vehicle is input, the customer management part 100 may receive, from the production information management part 210, the information on the target vehicle that does not affect the due dates of other vehicles, even when the due date of the purchased vehicle is exchanged with the due date of the target vehicle among the planned vehicles for which the production planning and the due dates have been previously set, and provide the information to the customer (S140).

The specific control method or the operation principle according to the customer management part 100, the production information management part 210, and the production planning management part 220 may be the same as previously described herein, and thus a repetitive description thereof will be omitted.

Accordingly, a customer may be able to move up a desired due date of a purchased vehicle from an expected due date, exchange the due date of a purchased vehicle with the due date of the target vehicle among planned vehicles for which a production planning and due dates have been previously set, by selecting a target vehicle that does not affect due dates of other vehicles.

In addition, an application and change of the due date of the purchased vehicle is possible after the time of purchase or after the time of purchase of the vehicle until the production planning of the purchased vehicle is established so that there is an advantage in that the customer can specifically confirm the desired due date of the purchased vehicle.

In accordance with a system and a method described herein, there are advantages as follows.

First, a customer can move up a desired due date of a purchased vehicle from an expected due date, even when exchanging the due date of the purchased vehicle with due dates of planned vehicles for which a production planning and due dates have been previously set, by selecting a target vehicle not affecting due dates of other vehicles, thereby changing a due date of a vehicle through a method of exchanging the due date of the purchased vehicle with a due date of a target vehicle.

Second, an application and change of the due date of the purchased vehicle is possible at the time of purchase or between the time of purchase of the vehicle and the production planning of the purchased vehicle is established so that the customer can specifically confirm the desired due date of the purchased vehicle.

The effects obtained by the present disclosure are not limited to the above-mentioned effects and other effects which are not mentioned can be clearly understood by those skilled in the art to which the present disclosure pertains from the above description.

Although the specific embodiments of the present disclosure have been described and illustrated, those skilled in the art will appreciate that various alternations and modifications are possible without departing from the technical spirit of the present disclosure provided in the appended claims.

What is claimed is:

1. A system comprising:
one or more processors; and
memory storing instructions that, when executed by the one or more processors, cause the system to:
receive a request for changing a delivery date of a purchased vehicle; and
select, among a plurality of planned vehicles for which production planning and delivery dates have been previously determined, a target vehicle, wherein exchanging the delivery date of the purchased vehicle with a delivery date of the target vehicle does not affect delivery dates of other planned vehicles of the plurality of planned vehicles;
exchange the delivery date of the purchased vehicle with the delivery date of the target vehicle; and
adjust a vehicle production schedule according to the exchanged delivery dates.

2. The system of claim 1, wherein the instructions, when executed by the one or more processors, further cause the system to:
store information on the plurality of planned vehicles; and
execute the vehicle production schedule based on the stored information.

3. The system of claim 1, wherein the instructions, when executed by the one or more processors, cause the system to select the target vehicle based on at least one of an amount of work or an amount of production time performed in a production process of the purchased vehicle.

4. The system of claim 3, wherein the instructions, when executed by the one or more processors, cause the system to select the target vehicle based on at least one of an amount of work or an amount of production time performed in a production process of the target vehicle being similar to a corresponding at least one of the amount of work or the amount of production time performed in the production process of the purchased vehicle.

5. The system of claim 3, wherein the instructions, when executed by the one or more processors, cause the system to not select, as the target vehicle, a vehicle having at least one of an amount of work or an amount of production time that is less than a corresponding at least one of the amount of work or the amount of production time performed in the production process of the purchased vehicle.

6. The system of claim 1, wherein the instructions, when executed by the one or more processors, cause the system to receive the request at a time of purchase of the purchased vehicle.

7. The system of claim 1, wherein the instructions, when executed by the one or more processors, cause the system to receive the request after a time of purchase of the vehicle before the production planning of the purchased vehicle is established.

8. The system of claim 1, wherein the instructions, when executed by the one or more processors, further cause the system to:
receive, from a user, an input comprising the request;
retrieve information on the plurality of planned vehicles; and
provide the information to the user.

9. The system of claim 1, wherein the instructions, when executed by the one or more processors, further cause the system to, based on receiving from a user an input comprising the request, retrieve information on the target vehicle and provide the information to the user.

10. A method comprising:
receiving, via one or more processors, a request for changing a delivery date of a purchased vehicle;
selecting, among a plurality of planned vehicles for which production planning and delivery dates have been previously determined, a target vehicle, wherein exchanging the delivery date of the purchased vehicle with a delivery date of the target vehicle does not affect delivery dates of other planned vehicles of the plurality of planned vehicles; and
exchanging the delivery date of the purchased vehicle with the delivery date of the target vehicle; and
adjusting a vehicle production schedule according to the exchanged delivery dates.

11. The method of claim 10, wherein the receiving of the request comprises receiving the request after a time of purchase of the vehicle and before the production planning of the purchased vehicle is established.

12. The method of claim 10, wherein the receiving of the request comprises receiving the request at a time of purchase of the purchased vehicle,
wherein the method further comprises generating, based on the request, order information of the purchased vehicle, and
wherein the adjusting of the vehicle production schedule comprises establishing the vehicle production schedule based on the order information.

13. The method of claim 10, further comprising, based on the receiving of the request, transmitting information on the request to a production information management server.

14. The method of claim 10, wherein the selecting of the target vehicle comprises selecting the target vehicle based on at least one of an amount of work or an amount of production time performed in a production process of the purchased vehicle.

15. The method of claim 10, further comprising:
receiving, from a user, an input comprising the request;
retrieving information on the target vehicle; and
providing the information to the user.
